(19) United States
(12) Patent Application Publication
(10) Pub. No.: US 2009/0265631 A1
(43) Pub. Date: Oct. 22, 2009

(54) SYSTEM AND METHOD FOR A USER INTERFACE TO NAVIGATE A COLLECTION OF TAGS LABELING CONTENT

(75) Inventors: Borkur Sigurbjornsson, Barcelona (ES); Roelof van Zwol, Badalona (ES)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/106,169

(22) Filed: Apr. 18, 2008

(51) Int. Cl. G06F 3/00

(52) U.S. Cl. 715/716

(57) ABSTRACT

An improved system and method for visualizing and navigating a collection of tags labeling content in a user interface is provided. A visualization displaying a categorized subset of related tags may be generated in a user interface from a collection of tags labeling content items. One or more tags may be submitted in a query, a ranked list of related tags may be determined and clustered into categories, and then the clusters of related tags may be sent to a client device for display. A client device may display the categories and the related tags in each category and representative content items labeled by the related tags. The search space of a collection of tags may be refined by adding additional tags to a search query or may be expanded by removing tags from a search query, and an updated visualization may be generated for the requested search scope.

### FIELD OF THE INVENTION

The invention relates generally to computer systems, and more particularly to an improved system and method for a user interface to navigate a collection of tags labeling content.

### BACKGROUND OF THE INVENTION

The collaborative efforts of users participating in social media services such as Wikipedia, Flickr, and Delicious have led to an explosion in user-generated content. The content can occur in various forms, such as text, photos, video, audio, or multimedia content. A popular way of organizing the content is through tagging. In fact, a considerable amount of such content is labeled by user-defined tags. The tags provided by the user provide useful descriptors of the content, especially in the case of multimedia. In Flickr, for example, users may upload and share photos, and may place tags on their own or others' photos. Such an online image sharing service may allow a user to append a tag to any photo in the system resulting in the addition of over a million tags each week to the collection of photos accessible through the service. For any of these applications, visualizing and navigating the space of such numerous tags presents a challenging task.

In order to explore content items in social media applications, there is a need for being able to browse the tags labeling and annotating the content items. Past techniques for visualizing this information have been functional but inadequate. Tag clouds are the de-facto means to visualize what tags are used to describe the content of the property or the collection. See http://flickr.com/photos/tags/ and http://del.icio.us/tag/ for examples. Unfortunately, this visualization can be difficult to interpret due to lack of organization. All the tags are mixed together in one big soup. For a large collection of tags, big tag clouds can be even more difficult to interpret. Furthermore, most tools for browsing tags only offer means to go from one tag to another, but do not offer the possibility of exploring the portion of the tag-space which is determined by a combination of tags or a query. As user-defined tags of content continue their explosive growth, users face the problem of exploring a potentially immense tag space without an ability to semantically explore such a collection of user-defined tags.

What is needed is a way to visualize and navigate a collection of user-defined tags by semantically exploring a user-defined collection of tags. Such a system and method should allow users to effectively explore tag spaces at any depth in the collection, and accordingly browse collections of tagged content items.

### SUMMARY OF THE INVENTION

Briefly, the present invention may provide a system and method for visualizing and navigating a collection of tags labeling content items in a user interface. In various embodiments, a client having a tag explorer may be operably coupled to a server for requesting tags and representative content items from storage. The tag explorer may generate a visualization in a user interface by displaying a categorized subset of related tags from a collection of tags labeling content items. The server may include an operably coupled tag subspace analyzer for selecting and ordering the categorized subset of related tags from the collection of tags labeling content items, a related tags engine for determining a subset of tags from the collection of tags labeling content items that are related to one or more tags in a query request, and a semantic classification engine for categorizing tags from the collection of tags.

The present invention may efficiently provide a user interface for navigating a collection of tags labeling content. To do so, one or more tags may be submitted in a query, a ranked list of related tags may be determined and clustered into categories, and then the clusters of related tags may be sent to a client device for display. A client device may display the categories and the related tags in each category by selecting a font size based upon a tag relatedness score that may represent the relative score of the tags. Representative content items labeled by the related tags may also be displayed.

Advantageously, the present invention may flexibly allow refining the search space of a collection of tags by adding additional tags to a search query or expanding the search space of the collection of tags by removing tags from a search query. The tag explorer may generate an updated visualization by displaying a categorized subset of related tags for the requested search scope from the collection of tags labeling content items. Online content publishing and social media applications may use the present invention for visualization and navigation of tags in a collection of tags labeling any types of content, including text, audio, images, video, multimedia content, and so forth. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for a user interface for visualization and navigation of a collection of tags labeling content, in accordance with an aspect of the present invention;

FIG. 3 is an illustration depicting in an embodiment a visualization of a subset of a collection of tags displayed on a client device, in accordance with an aspect of the present invention;

FIG. 4 is an illustration depicting in an embodiment a visualization of a subset of a collection of tags related to an individual tag requested by a user, in accordance with an aspect of the present invention;

FIG. 5 is an illustration depicting in an embodiment a visualization of a subset of a collection of tags related to tags requested by a user to refine a search of the collection of tags, in accordance with an aspect of the present invention;

FIG. 6 is an illustration depicting in an embodiment a visualization of a subset of a collection of tags related to an individual tag requested by a user that includes representative content items labeled by the subset of tags, in accordance with an aspect of the present invention;

FIG. 7 is an illustration depicting in an embodiment a visualization of a subset of a collection of tags related to tags requested by a user to refine a search of a collection of tags that includes representative content items labeled by the subset of tags, in accordance with an aspect of the present invention;

FIG. 8 is a flowchart generally representing the steps undertaken in one embodiment for visualization and navigation of a subset of a collection of tags labeling content in a user interface, in accordance with an aspect of the present invention;

FIG. 9 is a flowchart generally representing the steps undertaken in one embodiment for processing a request for visualization and navigation of a subset of a collection of tags labeling content in a user interface, in accordance with an aspect of the present invention; and

FIG. 10 is a flowchart generally representing the steps undertaken in one embodiment for displaying a subset of tags from a collection of tags labeling content items in a user interface, in accordance with an aspect of the present invention.

### DETAILED DESCRIPTION

### Exemplary Operating Environment

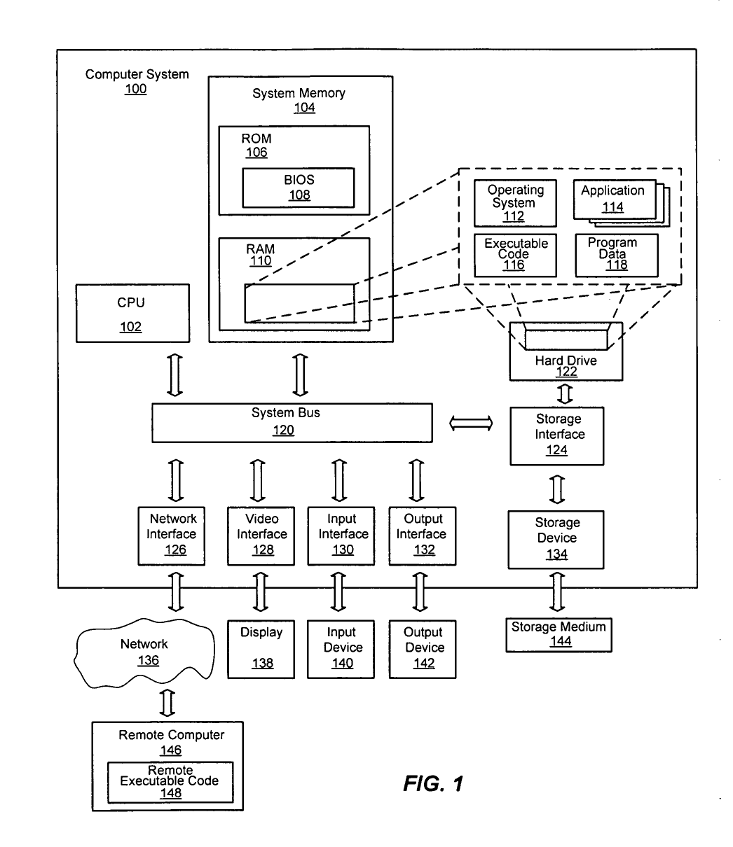

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### A User Interface for Visualization and Navigation of a Collection of Tags Labeling Content

The present invention is generally directed towards a system and method for visualization and navigation of a collection of tags labeling content items in a user interface. More particularly, the present invention may generate a visualization of a subspace of a collection of tags labeling content items in a user interface. As used herein, a tag means information that may label or annotate any type of content item including content such as text, audio, image, video, and multimedia content. A user may interact with the visualization of a subspace of the collection of tags to refine or expand the visualization of the subspace of the collection of tags. And an updated visualization may be generated for the requested search scope.

As will be seen, the techniques described may be applied for online content publishing and social media applications for visualization and navigation of tags in a collection of tags labeling any types of content, including text, audio, images, video, multimedia content, and so forth. As will be understood, the various block diagrams, flow charts and scenarios described herein are only examples, and there are many other scenarios to which the present invention will apply.

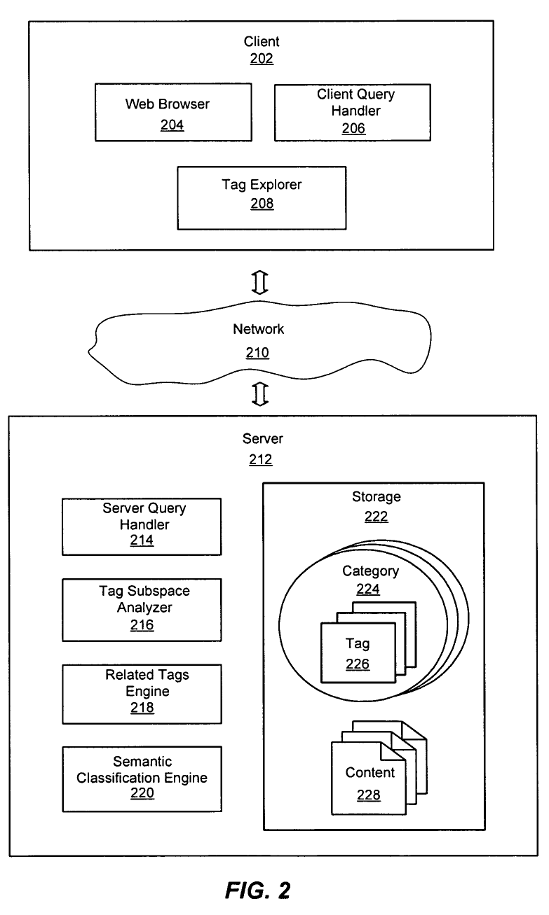

Turning to FIG. 2 of the drawings, there is shown a block diagram generally representing an exemplary architecture of system components for a user interface to visualize and navigate a collection of tags labeling content. Those skilled in the art will appreciate that the functionality implemented within the blocks illustrated in the diagram may be implemented as separate components or the functionality of several or all of the blocks may be implemented within a single component. For example, the functionality for the tag explorer 208 may be included in the same component as the web browser 204. Or the functionality of the tag explorer 208 may be implemented as a separate component from the web browser 204 as shown. Moreover, those skilled in the art will appreciate that the functionality implemented within the blocks illustrated in the diagram may be executed on a single computer or distributed across a plurality of computers for execution. Moreover, those skilled in the art may also appreciate that the functionality of the present invention may also be implemented using a thin client whereby the functionality of the client query handler 206 and the tag explorer 208 may be implemented on the server 212. In an embodiment, a web browser 204 may send a request with information about user interaction to the server 212 using an URL with parameters. The request with the URL may be processed by the server, and the server may then send back to the client an HTML document that is ready for display by the web browser 204.

In various embodiments, a client computer 202 may be operably coupled to one or more servers 212 by a network 210. The client computer 202 may be a computer such as computer system 100 of FIG. 1. The network 210 may be any type of network such as a local area network (LAN), a wide area network (WAN), or other type of network. A web browser 204 may execute on the client computer 202 and may include functionality for requesting visualization of a subset of a collection of tags labeling content in storage. The web browser 204 may be operably coupled to a client query handler 206 and a tag explorer 208. The client query handler 206 may include functionality for receiving a request from the web browser for obtaining content and for sending a request to a server to obtain content from storage. The tag explorer 208 may include functionality for visualization and navigation of tags in a collection of tags labeling content. In general, the web browser 204, the client query handler 206, and the tag explorer 208 may be any type of interpreted or executable software code such as a kernel component, an application program, a script, a linked library, an object with methods, and so forth.

The server 212 may be any type of computer system or computing device such as computer system 100 of FIG. 1. The server 212 may provide services for accessing and storing tags and the content items labeled by the tags. The server 212 may also provide services for categorizing tags and selecting related tags. The server 212 may include a server query handler 214 for receiving and responding to requests for tags labeling content items. The server 212 may include a tag subspace analyzer 216 for selecting and ordering a subset of the collection of tags. The server 212 may also include a related tags engine 218 for determining a subset of tags from the collection of tags that are related to tags requested in a search query. The server 212 may additionally include a semantic classification engine 220 for categorizing tags in the collection of tags. Each of these modules may also be any type of executable software code such as a kernel component, an application program, a linked library, an object with methods, or other type of executable software code.

The server 212 may be operably coupled to storage of content items such as storage 222 that may include any type of content item 228 that may be labeled with a tag 226. In an embodiment, each tag 226 may be any type of keyword annotation of a content item 228, including for example bookmarks, photos, videos, video fragments, text, audio, and other multimedia content. Each tag 226 may be classified into a category 224.

There are many applications which may use the present invention for visualization and navigation of tags in a collection of tags labeling content. Online content publishing and social media applications are examples among these many applications. For any of these applications, new tags may be generated daily for both new and existing content items, and these additional tags may be incorporated into a collection of tags labeling content items. For instance, an online photographic sharing application may allow users to upload and share photographs, and may also allow users to annotate the photographs with tags. Such an application may provide an opportunity for communities of users to build a layer of information on top of a base of content using tags and annotations. Those skilled in the art may recognize that other online applications such as news article feeds, blogs or bulletin boards, and multimedia data applications such as images, songs, or movie clips may similarly have tags generated on top of the content. Such applications may use the present invention for visualizing and navigating tags labeling content items.

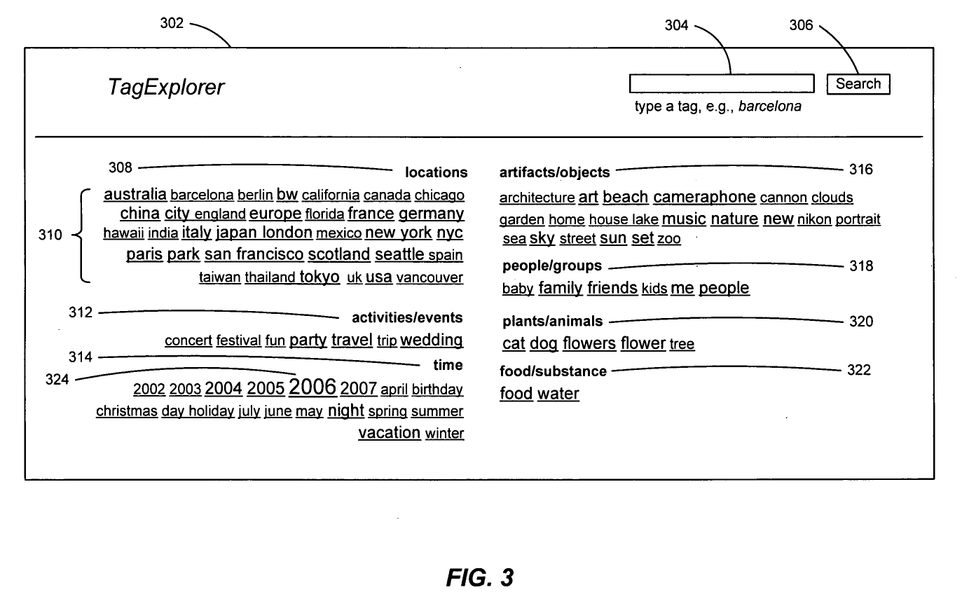

For example, FIG. 3 depicts in an embodiment a visualization of a subset of a collection of tags displayed on a client device. A display of a web browser 302 is illustrated in FIG. 3 and may include a text input field 304 and a search button 306, so a user may request a search for a tag entered in the text input field 304. In the embodiment illustrated in FIG. 3 for example, popular tags in an online photographic sharing application are displayed using semantic classification of the tags and using different font sizes to depict the relative score of the tags. For instance, related tags may be displayed by categories such as location 308, activities/events 312, time 314, artifacts/objects 316, people/groups 318, plants/animals 320, and food/substance 322. The tags classified within a particular category may be displayed underneath the category such as tags 310 displayed underneath location 308. Each tag may be displayed using a font size to indicate the relative tag score. In the illustration of FIG. 3, the font size of the tag, 2006, 324 is larger than the font size of other tags occurring within the category of time 314 and within other categories displayed.

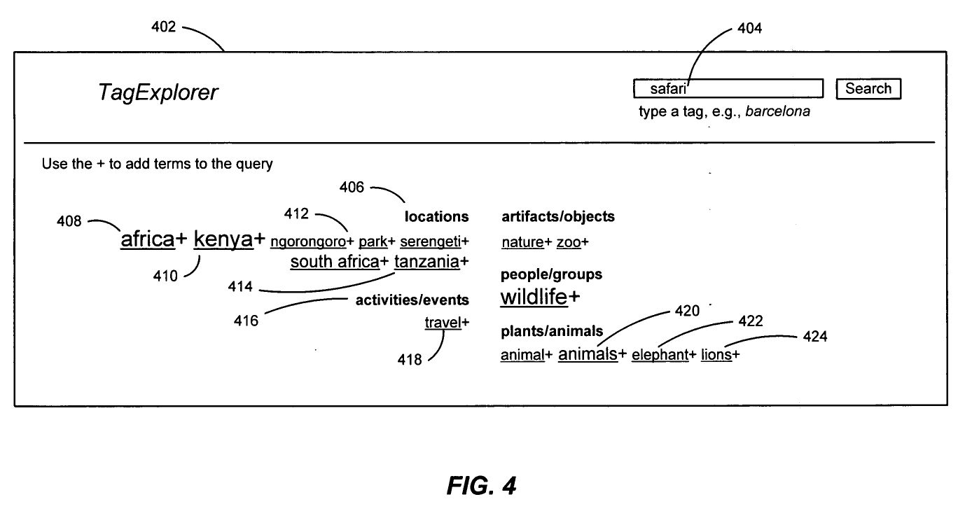

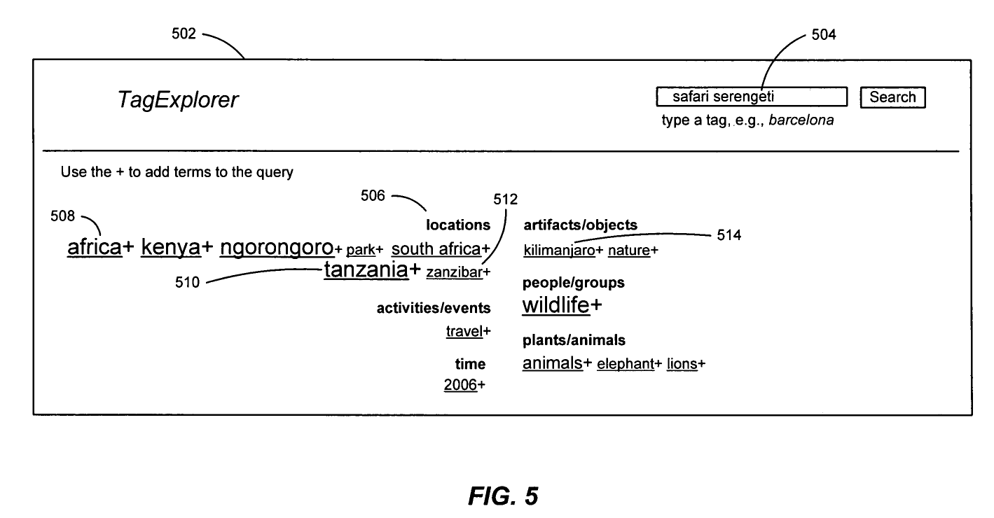

A user may choose to browse the collection of tags represented by the subset of popular tags displayed in FIG. 3. In general, FIGS. 4 and 5 may illustrate a browsing session of a collection of tags. In particular, FIG. 4 depicts in an embodiment a visualization of a subset of a collection of tags related to an individual tag requested by a user. A user may enter “safari”, for example, in the text input field 404 of the web browser 402 to request a search of the tag “safari” in the collection of tags. A subset of relevant tags may be determined by finding tags that co-occur with the tag submitted in the search request. Then the subset of relevant tags may be classified into categories and displayed by their categories. Accordingly, the category of location 406 has been updated to include locations such as Africa 408, Kenya 410, Serengeti 412, and Tanzania 414. Note that relevant activities in the category of activities/events 416 are also refined to reflect the single tag of travel 418. And the category of plants/animals 420 has been updated to display relevant tags such as animals 422, elephant 424 and lion 426.

A user can choose to continue exploring the collection of tags by either adding tags to the tags of the search query, removing tags from the tags of the search query, or choosing one or more new tags for a search query. For instance, a user may choose to add “Serengeti” as a tag in the search query so that relevant tags for “safari Serengeti” may be explored. This is depicted in FIG. 5 which illustrates in an embodiment a visualization of a subset of a collection of tags related to tags requested by a user to refine a search of the collection of tags. By adding the tag “Serengeti” to the tag “safari” in the text input field 504 of the web browser 502 to refine the search query, the tags Africa 508 and Tanzania 510 in the category of location 506 become more relevant. Notice that the font size used to display each of these tags has increased to reflect a higher tag score of the relevance of each of these tags. Additionally, Zanzibar 512 and Kilimanjaro 514 appear among the tags related to Serengeti. Those skilled in the art will appreciate that tags may also be added to a search query in various embodiments, for instance by using an input device to select a plus sign displayed to the right of the corresponding tag.

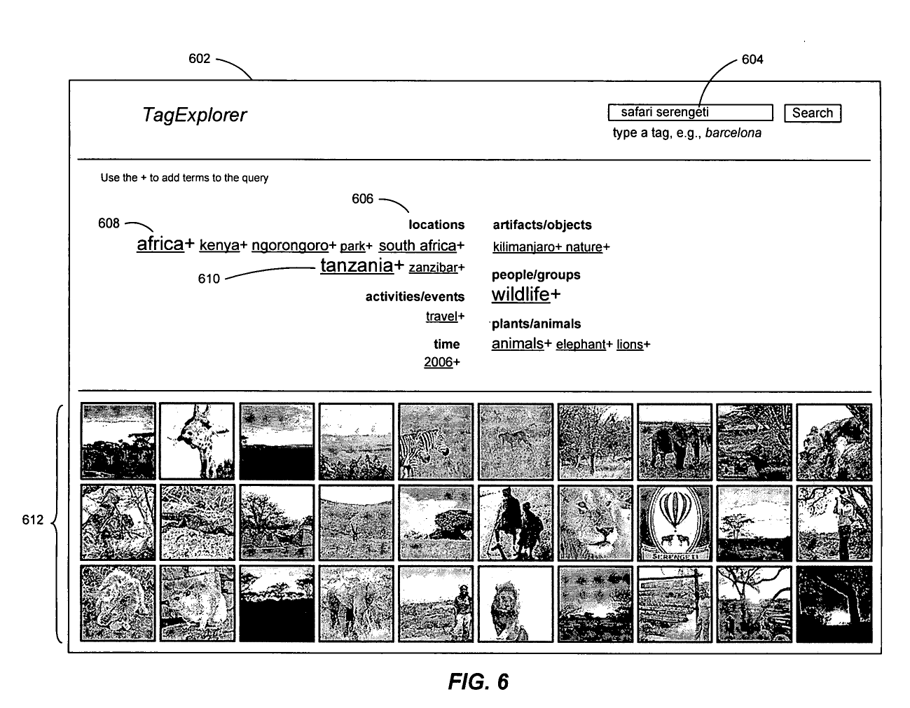

The visualization of a subset of a collection of tags may also include a display of content items labeled by the subset of tags displayed. In an online photographic sharing application, representative images labeled by the subset of tags may also be displayed as illustrated in FIG. 6. The web browser 602 illustrated in FIG. 6 includes the tag search query of “safari Serengeti” in the text input field 604, and shows the resulting tags Africa 608 and Tanzania 610 in the category of location 606 and also photos 612 shown in a display area for representative content items labeled by the subset of tags categorized above.

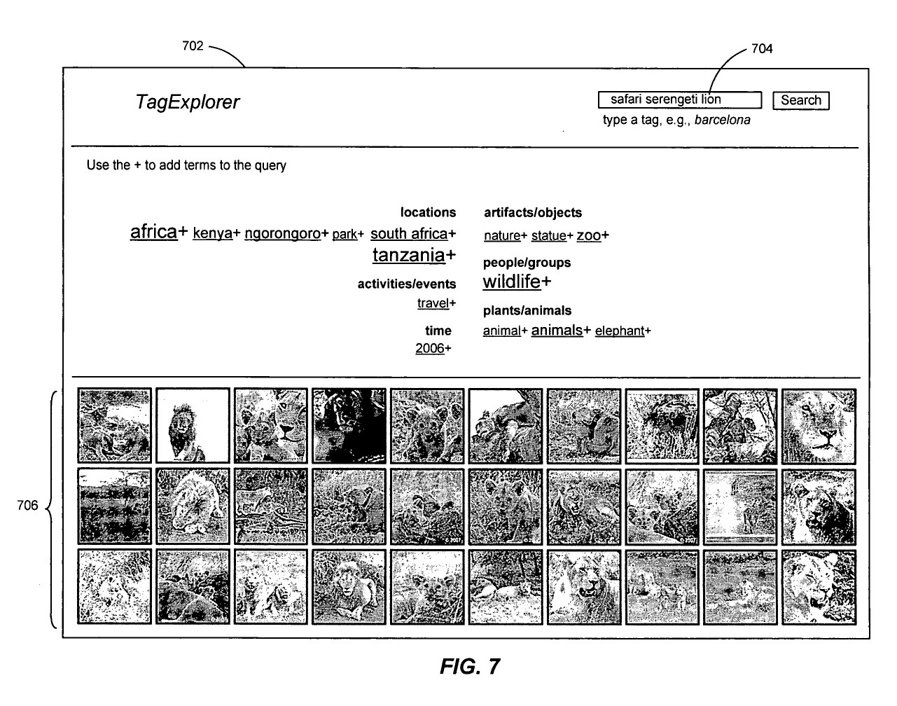

FIG. 7 illustrates in an embodiment a visualization of a subset of a collection of tags related to tags requested by a user to refine a search of a collection of tags and representative content items labeled by the subset of tags. The web browser 702 illustrated in FIG. 7 includes the tag search query of “safari serengeti lion” in the text input field 704, and shows the resulting categorized tags and photos 706 shown in a display area for representative content items labeled by the subset of tags categorized above. The representative photographs displayed for the refined tag query include images of lions. Users may accordingly navigate the collection of tags and effectively explore labeled content items at any depth in the collection. While exploring the collection, the user is provided with categories that describe semantic characteristics of the particular subset of tags viewed in the collection.

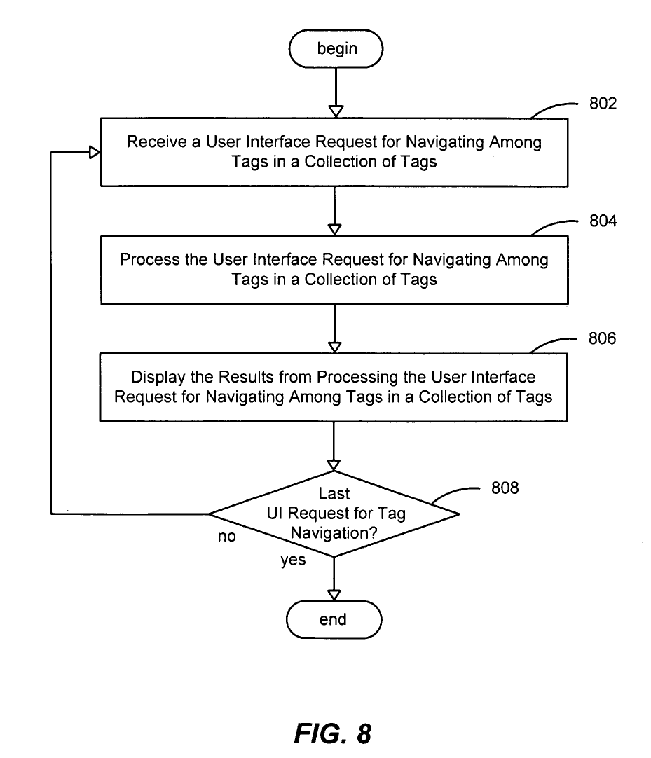

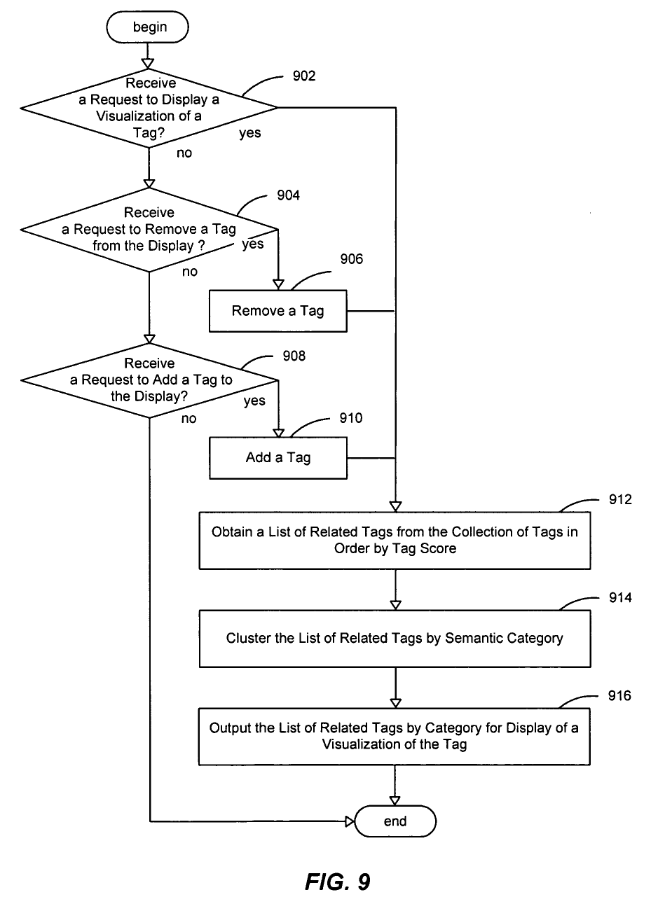

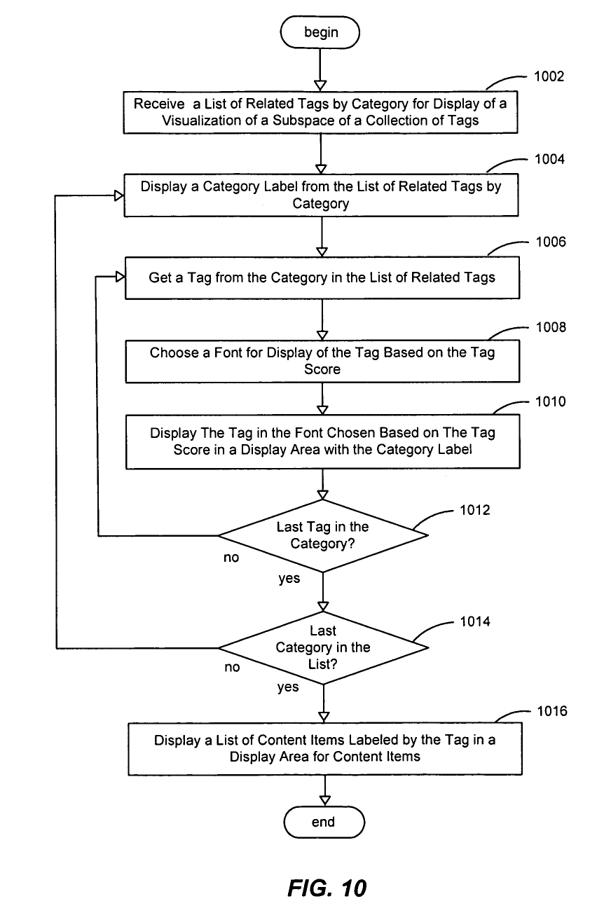

FIG. 8 presents a flowchart generally representing the steps undertaken in one embodiment for visualization and navigation of a subset of a collection of tags labeling content in a user interface. For example, a web browser executing on a client computer may request visualization of tags describing content items, such as tags annotating photographs shared online. At step 802, a user interface request may be received for visualization and navigation of a subset of tags from a collection of tags labeling content items. In an embodiment, an input text field may be provided for entering a tag to be submitted in a search request. In various embodiments, a tag may also be selected from a display of tags. Or a tag may be added or removed from a display of tags in a user interface or from an input text field. In any case, the user interface request for visualization and navigation of a subset of tags from a collection of tags labeling content items may be processed at step 804. Processing user interface requests for displaying a subset of tags from a collection of tags labeling content items may be described in more detail in conjunction with FIG. 9. The subset of tags selected from processing the request may be displayed at step 806. Displaying a subset of tags from a collection of tags labeling content items may be described in more detail in conjunction with FIG. 10. It may then be determined at step 808 whether another user interface request may be received for visualization and navigation of a subset of tags from a collection of tags labeling content items. If so, then processing may continue at step 804. Otherwise, processing may be finished for visualization and navigation of a subset of a collection of tags labeling content in a user interface.

FIG. 9 presents a flowchart generally representing the steps undertaken in one embodiment for processing a request for visualization and navigation of a subset of a collection of tags labeling content in a user interface. At step 902, it may be determined whether a request for a new tag, or tags, may be received for processing a user interface operation for visualization and navigation of a subset of a collection of tags labeling content. In an embodiment, a user may make a request to search for a new tag(s) by entering the new tag(s) in an input text field of the user interface. If so, processing may be continued at step 912 for the tag(s) in the search query.

Otherwise, if the request received may not be a request for a new tag, then it may be determined at step 904 whether a request may be received for removing one or more tags from the previous search string of tags. In an embodiment, a user may make a request to remove a tag from the tags of a search query by deleting one or more tags from the previous search string displayed in the text input field for a search query. If so, one or more tags may be removed from the list of tags in the search query at step 906 and processing may be continued at step 912 for the tag(s) in the modified search query.

If the request received may not be a request to remove one or more tags from the tags of a search query, then it may be determined at step 908 whether a request may be received for adding one or more tags to the previous search string of tags. In an embodiment, a user may make a request to add one or more tags to the tags of a search query by adding one or more tags to the previous search string displayed in the text input field for a search query. If a request is received for adding one or more tags, one or more tags may be added to the tag(s) in the search query at step 910 and processing may continue at step 912.

At step 912, a list of related tags in order by tag relatedness score may be obtained for the tag(s) in the search query from the collection of tags. To obtain a list of related tags in order by tag relatedness score for the tag(s) in the search query from the collection of tags, any ranked list of tags with a score may be used, including a list of most popular tags, a list of most recent tags, or a list of the most related tags for the tag(s) in the search query. For example, to determine a list of the most related tags for the tag(s) in the search query, tags that co-occur for content items in the collection of content items tagged by the collection of tags may be selected as related tags and ranked in order of their frequency of co-occurrence.

In particular, a list of related tags may be obtained by generating pairs of tags from each of the terms in a tag labeling an individual content item in the collection of content items tagged by the collection of tags. For example, if a content item such as a photo has the tag “Eiffel Tower, Paris, France”, the following pairs of tags may be generated: (Eiffel Tower, Paris), (Eiffel Tower, France), (Paris, France). The frequency of the co-occurrence of each pair of terms in tags may be counted for all of the content items in the collection of content items tagged by the collection of tags. This list of related tags with their frequency of co-occurrence may then be used to obtain a list of relevant tags in order by tag relatedness score for the tag(s) in the search query.

From the list of related tags with their frequency of co-occurrence, a list of related tags with their tag relatedness score may be obtained for each tag in the search query, and these lists may be merged to generate a single ranked list of relevant tags for the search query in order by a tag relatedness score. The tag relatedness score can be calculated in several ways using either symmetric or asymmetric co-occurance measures. For example, for a query term q and a related term c, the score for c can be calculated using the probability of c given q, |q∩c|/|q|, the probability of q given c, |c∩q|/|c|, or the Jaccard-coefficient of q and c, |q∩c|/|q ∪c|. The lists may be merged to generate a single ranked list of relevant tags in a number of ways, including by voting. For instance, the appearance of a tag in a list counts as a vote for that tag. Tags may then be ordered by decreasing number of votes. Those skilled in the art will appreciate that the voting algorithm can be altered in many ways where the weight of each vote may be biased toward a set of tags with desired characteristics. For example, weights may depend upon the score of the related tag according to the co-occurrence measure, the rank of the related tag in the list of related tags, the frequency of the tag in the search query for which the list was generated, the frequency of the related tag, and so forth.

Upon obtaining a list of related tags in order by a tag relatedness score, the list of relevant tags may be clustered at step 914 by semantic category. In an embodiment, the list of related tags may be classified in categories by matching the tags using anchor texts with categories of web pages in a hyperlinked corpus of classified web pages as described in related copending U.S. Patent Application, Attorney Docket No. 1780, entitled “SYSTEM AND METHOD FOR CLASSIFYING TAGS OF CONTENT USING A HYPERLINKED CORPUS OF CLASSIFIED WEB PAGES,” assigned to the assignee of the present invention. At step 916, the list of related tags may be output by semantic category for display of a visualization of the tags.

FIG. 10 presents a flowchart generally representing the steps undertaken in one embodiment for displaying a subset of tags from a collection of tags labeling content items in a user interface. At step 1002, a list of related tags by category may be received for display of a visualization of a subset of a collection of tags. For instance, a web browser may receive a list of categorized tags from a server in an embodiment for display of a visualization and navigation of a subset of a collection of tags. In general, each category label may be selected and then the tags classified in that category may be displayed until each category with its classified tags has been displayed. Accordingly, a category label may be displayed at step 1004 from the list of categorized tags. In various embodiments, category labels may be grouped in a hierarchy. For instance, categories may be grouped by “where” signifying the location, “what” signifying the subject matter or actions, and “when” signifying the time period. Those skilled in the art will appreciate that other hierarchical orderings of categories may be used. In various other embodiments, category label may be selected by frequency of content items in a particular category or in alphabetical order.

After a category label may be selected for display from the list of categorized tags, a tag classified in the category may be obtained at step 1006 from the list of categorized tags and a font size may be selected at step 1008 for display of the tag based upon the tag score. The higher the tag score, the larger the relative font size may be to reflect a higher tag score of the relevance of the tag. And at step 1010, the tag may be displayed in the display area with the category label using the selected font size based on the tag score.

At step 1012, it may be determined whether the last tag in the given category has been displayed. If not, then processing may continue at step 1006 by obtaining a tag classified in the given category from the list of categorized tags. Otherwise, it may be determined at step 1014 whether the last category in the list of categorized tags has been displayed. If not, then processing may continue at step 1004 by displaying a category label from the list of categorized tags. Otherwise, a list of representative content items labeled by the tags from the list of categorized tags may be displayed at step 1016 in a display area for content items, and processing may be finished. In various embodiments, the display area for content items may be below the display area for the categorized tags.

Thus the present invention may generate a visualization in a user interface of a subspace of a collection of tags labeling content items by displaying a categorized subset of related tags from the collection of tags. A user may interact with the visualization of a subspace of the collection of tags to refine or expand the visualization of the subspace of the collection of tags. For instance, a user may refine the visualization of a subspace of the collection of tags by adding tags to a search query. Or a user may expand the visualization of a subspace of the collection of tags by removing tags from a search query. An updated visualization may be generated by displaying a categorized subset of related tags for the requested search scope from the collection of tags labeling content items. Those skilled in the art will appreciate that other controls and implementations may be used for changing the search scope of the subspace of the visualization of the collection of tags. For example, a symbol such as a plus sign may be displayed to the right of each tag so that a user may add tags to a query by clicking the plus sign to the right of the corresponding tag.

As can be seen from the foregoing detailed description, the present invention provides an improved system and method for visualization and navigation of a collection of tags labeling content items in a user interface. Related tags may be determined for a query and clustered into categories. The categories, the related tags in each category, and representative content items labeled by the related tags may then be displayed. The system and method may apply broadly to visualizing and navigating a collection of tags labeling any types of content, including text, audio, images, video, multimedia content, and so forth. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for visualization of tags in a user interface, comprising:
a tag explorer for generating a visualization in a user interface depicting a categorized subset of related tags from a collection of tags labeling content items;
a tag subspace analyzer operably coupled to the tag explorer for selecting and ordering the categorized subset of related tags from the collection of tags labeling content items; and
a storage operably coupled to the tag subspace analyzer for storing a plurality of categories of a plurality of classified tags, each of the plurality of classified tags labeling a content item.

2. The system of claim 1 further comprising a related tags engine operably coupled to the tag subspace analyzer for determining a plurality of tags related to at least one tag from the collection of tags labeling content items.

3. The system of claim 1 further comprising a semantic classification engine operably coupled to the tag subspace analyzer for categorizing a plurality of tags from the collection of tags.

4. The system of claim 1 further comprising a query handler operably coupled to the tag subspace analyzer for sending a request to obtain the categorized subset of related tags from the collection of tags labeling content items.

5. A computer-readable medium having computer-executable components comprising the system of claim 1.

6. A computer-implemented method for visualization of tags in a user interface, comprising:
receiving at least one tag in a collection of tags;
determining a plurality of tags related to the at least one tag in the collection of tags;
clustering into at least one category the plurality of tags related to the at least one tag in the collection of tags; and
outputting by the at least one category the plurality of tags related to the at least one tag in the collection of tags.

7. The method of claim 6 wherein receiving the at least one tag in the collection of tags comprises receiving a user interface request with the at least one tag for visualization of a subset of tags from a collection of tags labeling content items.

8. The method of claim 6 wherein outputting by the at least one category the plurality of tags related to the at least one tag in the collection of tags comprises displaying on a client device the plurality of tags related to the at least one tag in the collection of tags by the at least one category.

9. The method of claim 6 wherein determining the plurality of tags related to the at least one tag in the collection of tags comprises obtaining a list of tags in order by tag relatedness score calculated using a co-occurrence measure.

10. The method of claim 6 wherein clustering into at least one category the plurality of tags related to the at least one tag in the collection of tags comprises matching the plurality of tags using anchor texts with one or more categories of one or more documents in a classified corpus of hyperlinked web documents.

11. The method of claim 8 wherein displaying on a client device the plurality of tags related to the at least one tag in the collection of tags by the at least one category comprises choosing a font size for at least one of the plurality of tags based upon a tag score for the at least one of the plurality of tags.

12. The method of claim 8 further comprising displaying on the client device a plurality of content items labeled by at least one of the plurality of tags related to the at least one tag in the collection of tags.

13. The method of claim 6 further comprising:
receiving at least two tags, including the at least one tag;
determining a plurality of tags related to the at least two tags, including the at least one tag;
clustering into a plurality of categories the plurality of tags related to the at least two tags, including the at least one tag; and
outputting by the plurality of categories the plurality of tags related to the at least two tags, including the at least one tag.

14. The method of claim 13 wherein outputting by the plurality of categories the plurality of tags related to the at least two tags, including the at least one tag, comprises displaying on a client device the plurality of tags related to the at least two tags, including the at least one tag, by the plurality of categories.

15. The method of claim 6 further comprising:
receiving one or more tags with the at least one tag removed;
determining a plurality of tags related to the one or more tags with the at least one tag removed;
clustering into a plurality of categories the plurality of tags related to the one or more tags with the at least one tag removed; and
outputting by the plurality of categories the plurality of tags related to the one or more tags with the at least one tag removed.

16. The method of claim 15 wherein outputting by the plurality of categories the plurality of tags related to the one or more tags with the at least one tag removed comprises displaying on a client device the plurality of tags related to the one or more tags with the at least one tag removed by the plurality of categories.

17. A computer-readable medium having computer-executable instructions for performing the method of claim 6.

18. A computer system for visualization of tags in a user interface, comprising:
means for generating a visualization in a user interface displaying a categorized subset of related tags from a collection of tags labeling content items;
means for navigating the collection of tags labeling content items by user interaction with the visualization in the user interface displaying the categorized subset of related tags from the collection of tags labeling content items; and
means for outputting the categorized subset of related tags from the collection of tags labeling content items for display to a user.

19. The computer system of claim 18 further comprising means for determining a plurality of tags related to at least one tag in the collection of tags.

20. The computer system of claim 18 further comprising means for clustering into at least one category a plurality of tags related to at least one tag in the collection of tags.
